(19) United States
(12) Patent Application Publication
(10) Pub. No.: US 2023/0288605 A1
(43) Pub. Date: Sep. 14, 2023

(54) SYSTEM AND METHOD FOR SEISMIC DEPTH UNCERTAINTY ESTIMATION

(71) Applicant: Chevron U.S.A. Inc., San Ramon, CA (US)

(72) Inventors: Huafeng Liu, Bellaire, TX (US); Andrey Hanan Shabelansky, Bellaire, TX (US); Jinsong Chen, Fulshear, TX (US)

(21) Appl. No.: 17/654,633

(22) Filed: Mar. 14, 2022

(51) Int. Cl. G01V 99/00; G01V 1/30; G01V 1/40

(52) U.S. Cl. CPC G01V 99/005; G01V 1/301; G01V 1/40

(57) ABSTRACT

A method is described for estimating depth uncertainty including receiving seismic data, a reference model, and trial model realizations; generating realization gathers from the trial model realizations; generating reference gathers from the reference model; determining a reference data fit based on the reference gathers and a data fit for trial models based on the realization gathers; selecting refined models from the trial model realizations based on the reference data fit, the data fit for trial models, and a data fit tolerance criterion; and calculating depth uncertainty based on statistics of the refined models. The method may be executed by a computer system.

### TECHNICAL FIELD

The disclosed embodiments relate generally to techniques for estimating depth uncertainty in seismic images and, in particular, a technique that provides a laterally-varying depth uncertainty estimate.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

Seismic data is processed to create seismic images that can be interpreted to identify subsurface geologic features including hydrocarbon deposits. Among all information a seismic image can provide, the depth of subsurface structures is of particular interest for prospect evaluation. Despite recent accuracy improvement from advanced acquisition and imaging technologies, a significant degree of depth uncertainty remains. The source of uncertainty comes from the combination of rock property variations and the limited surface locations to acquire band-limited seismic data. Given these limitations, a quantitative and accurate estimation of depth uncertainty is essential for accurate prospect evaluation.

There have been various attempts to estimate depth uncertainty. Samples of depth uncertainty measurements can be obtained from well mis-ties (i.e., the disconnect between a particular interpreted seismic horizon and the corresponding rock formation identified in a well log). While mis-ties are direct samples of depth information, they are often limited in subsurface locations and, therefore, lack of predicting power of other subsurface locations of interest. On the other hand, a set of seismic models (including velocity and anisotropy) that provides acceptable seismic images can be used to estimate depth uncertainty. Due to the extremely large model space and the computational cost of the most advanced seismic imaging technics, strong assumptions are common practice to enable feasible estimation. One common practice is to assume locally 1D models. When subsurface geology varies laterally, the accuracy of the depth uncertainty estimation with the 1D assumption is reduced. In addition, this particular approach does not use seismic data directly in the estimation, which limits its capability to use the full information contained in seismic data. In addition to the limitation of the locally-1D assumption, this practice assumes the input model for depth uncertainty analysis has perfectly flat seismic gathers. In reality, the seismic gathers are unlikely to be exactly flat at all subsurface locations, further limiting the accuracy of conventional method.

As the depth uncertainty is used as data point to determine drilling activities, there exists a need for improved depth uncertainty estimation.

### SUMMARY

In accordance with some embodiments, a method of estimating depth uncertainty including receiving seismic data, a reference model, and trial model realizations; generating realization gathers from the trial model realizations; generating reference gathers from the reference model; determining a reference data fit based on the reference gathers and a data fit for trial models based on the realization gathers; selecting refined models from the trial model realizations based on the reference data fit, the data fit for trial models, and a data fit tolerance criterion; and calculating depth uncertainty based on statistics of the refined models is disclosed.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates an example system for estimating depth uncertainty;

FIG. 2 is a flowchart for estimating depth uncertainty;

FIG. 3 illustrates examples of a step in an embodiment;

FIG. 4 illustrates examples of a step in an embodiment;

FIG. 5 illustrates examples of a step in an embodiment;

FIG. 6 illustrates examples of a step in an embodiment;

FIG. 7 illustrates examples of a step in an embodiment;

FIG. 8 illustrates examples of a step in an embodiment;

FIG. 9 illustrates examples of a step in an embodiment;

FIG. 10 illustrates examples of a step in an embodiment;

FIG. 11 illustrates results of a method for estimating depth uncertainty; and

FIG. 12 illustrates results of a method for estimating depth uncertain.

Like reference numerals refer to corresponding parts throughout the drawings.

### DETAILED DESCRIPTION OF EMBODIMENTS

Described below are methods, systems, and computer readable storage media that provide a manner of estimating depth uncertainty using seismic data. These embodiments are designed to be of particular use for estimating depth uncertainty where there is lateral variation in the subsurface volume of interest.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

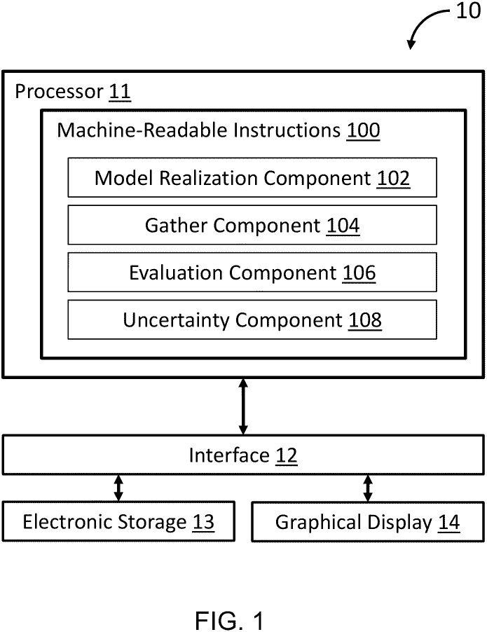

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a graphical display 12, and/or other components. The processor 11 is configured to execute machine-readable instructions 100 that perform a method that estimates depth uncertainty. The method has multiple advantages including honoring lateral variations of subsurface properties, measuring the quality of gathers (rather than assuming perfectly flat gathers), and using waveform information contained in seismic data.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to seismic data, seismic images, well logs, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to model realizations, seismic data and images, depth uncertainty, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate depth uncertainty estimation. The machine-readable instructions 100 may include one or more computer program components. The machine-readable instructions 100 may include a model realization component 102, a gather component 104, an evaluation component 106, an uncertainty component 108, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the model realization component 102 may be configured to generate a large set of trial seismic model realizations that could provide reasonable seismic images, meaning that seismic data generated for the models could be used for seismic imaging.

The gather component 104 may be configured to generating seismic gathers based on 3D physics efficiently from a large set of the trial seismic model realizations.

The evaluation component 106 may be configured to evaluate the quality of the gathers. The evaluation component 106 uses a selection criterion to identify the high-quality model realizations based on 3D data fit.

The uncertainty component 108 may be configured to estimate the depth uncertainty based on statistics of the selected high-quality model realizations.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

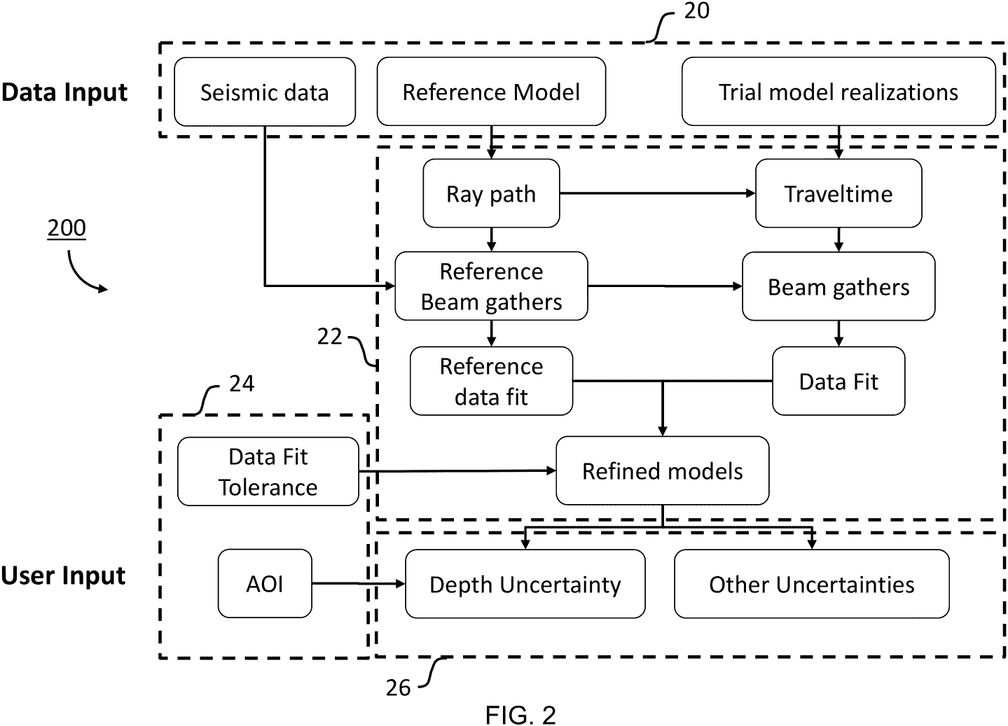

FIG. 2 illustrates an example process 200 for depth uncertainty estimation. The process includes generating a large set of trial seismic models that could provide reasonable seismic images, generating seismic gathers based on 3D physics efficiently from a large set of the trial seismic models, and an evaluation system to quantify a depth uncertainty estimation based on the models that satisfy a selection criterion defined by the evaluation system.

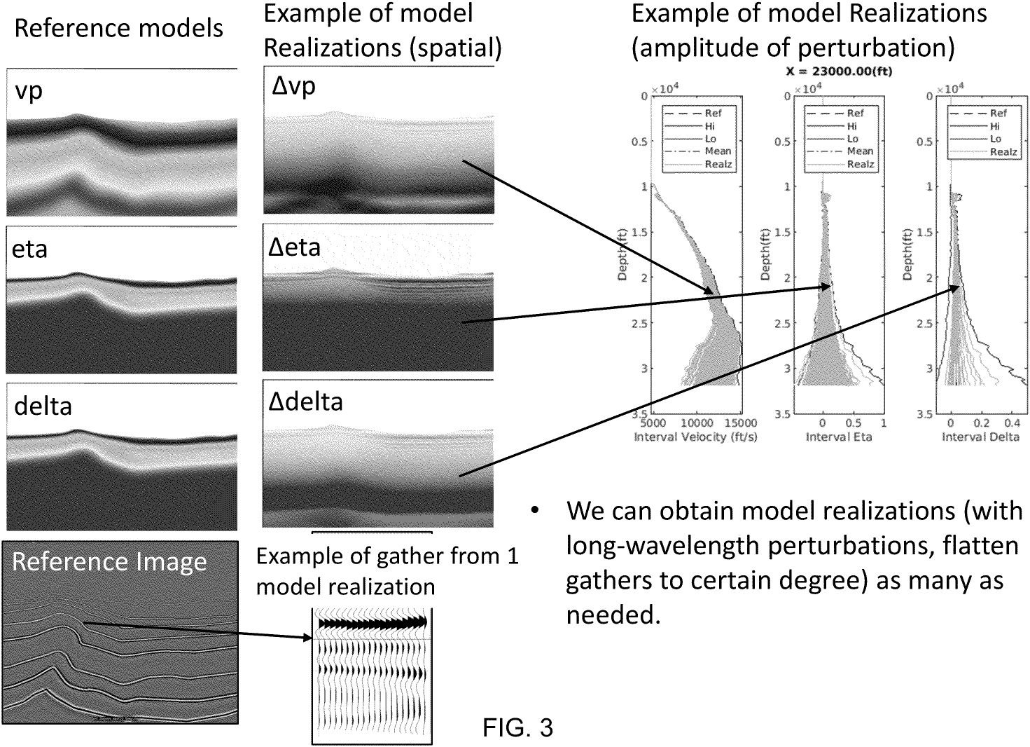

The input for the process is indicated in box 20. The seismic data and a reference model including information on seismic velocity V and anisotropic parameters η and δ. Although the initial model realizations are considered input here, the method may include generating trial model realizations. This may be done, by way of example and not limitation, by a stochastic modeling approach that generates models of velocity V and anisotropic parameters η and δ. Such an approach may be based on high and low bounds of normal moveout velocity (Vₙₘₒ) and η which can be used to define bounds on V and δ. These bounds can then be used to generate many trial model realizations for V, η, and δ. Examples of the reference models and trial model realizations can be seen in FIG. 3.

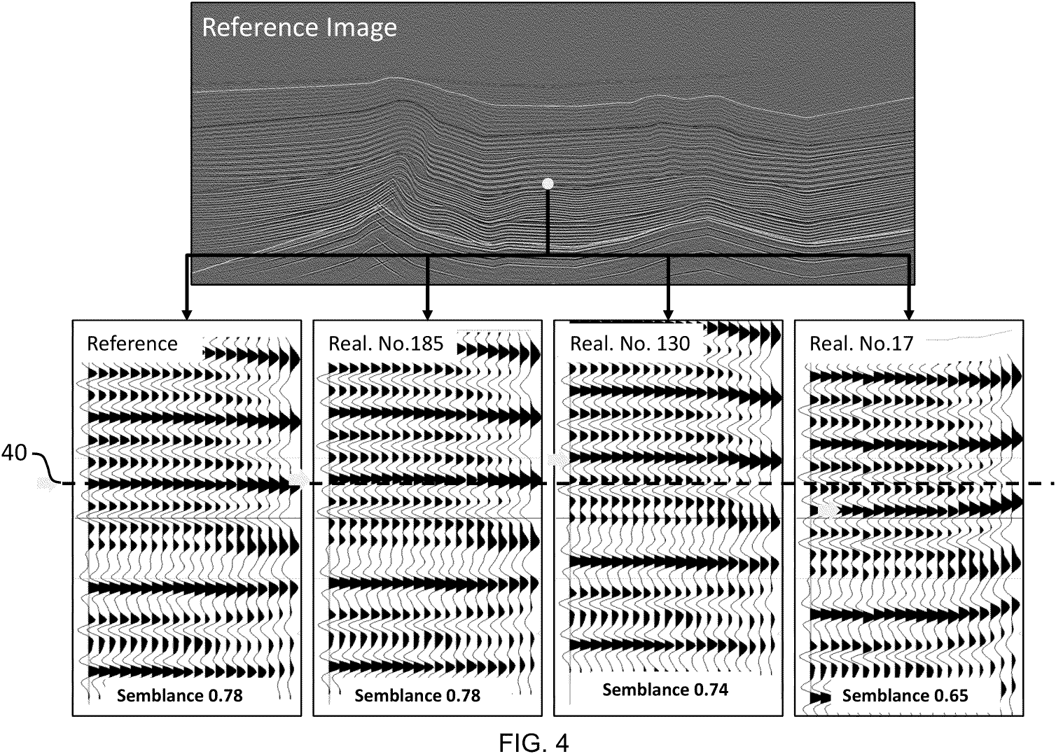

Referring again to FIG. 2, box 22 illustrated the steps of the method. It begins with an efficient way to compute traveltime perturbations. We obtain a reference gather from a reference model, such as gaussian-beam based gathers, which may be done, for example, using a method similar to that described in U.S. Pat. 11,047,999. The method traces ray paths through the input reference model and used the seismic data input to build reference seismic gathers, such as but not limited to beam gathers. The method uses model perturbations from trial model realizations that are different from the reference model and computes corresponding traveltime perturbations. Last, the method forms new gathers that correspond to all trial model realizations by shifting traveltime on the reference gather. As a result, the impact of trial models on pre-stack seismic is quantified and can be further evaluated. FIG. 4 shows examples of gathers generated for the reference model and 3 different model realizations. The horizontal dashed line 40 illustrates how flat one particular event is in each model realization.

The method moves on to measure the quality of gathers from trial model realizations. In an embodiment, this may be done using semblance that describes the similarity of traces (signal from varying subsurface directions) at all gather locations. We define a 3D-data fit, which in an embodiment may be the average of semblance at all available subsurface locations, to represent the quality of models. The data fit is determined for the reference model, producing a reference data fit, and for all trial model realizations, producing a data fit for each model realization.

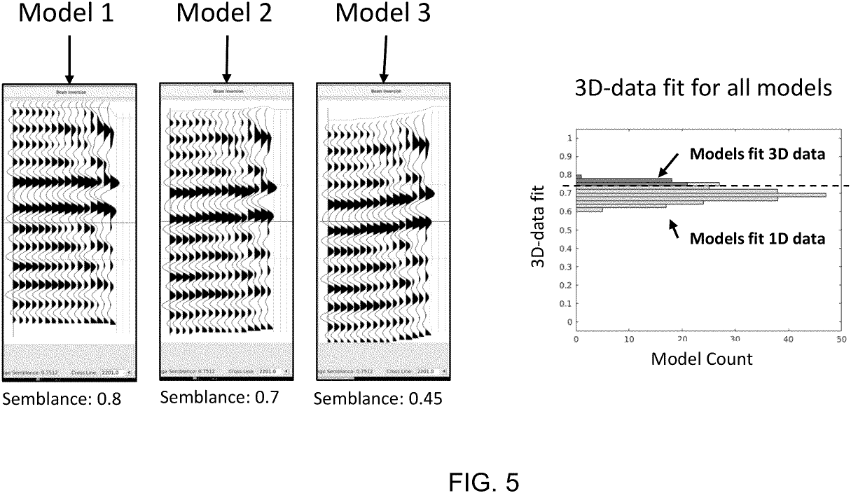

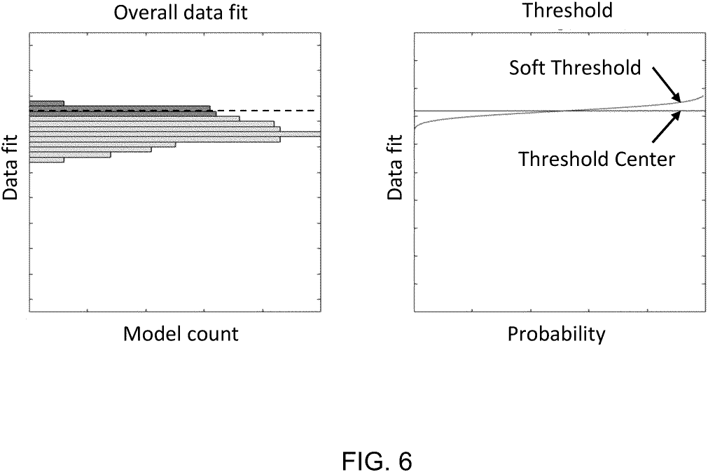

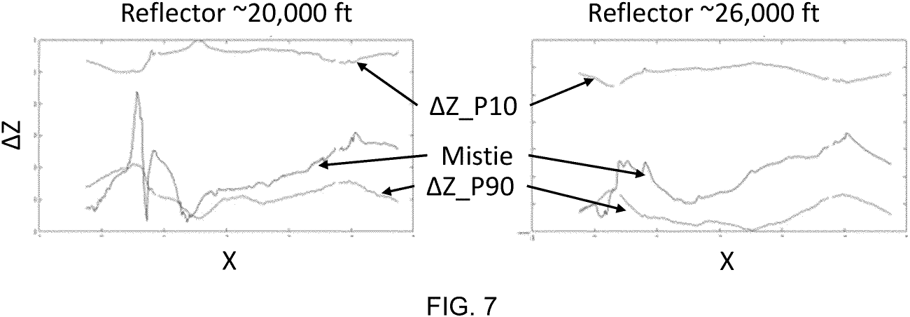

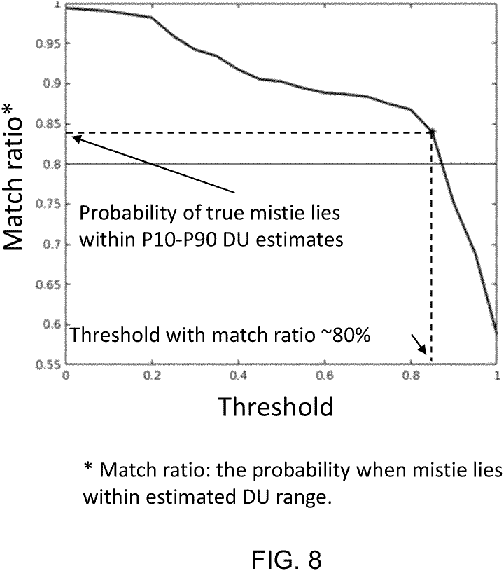

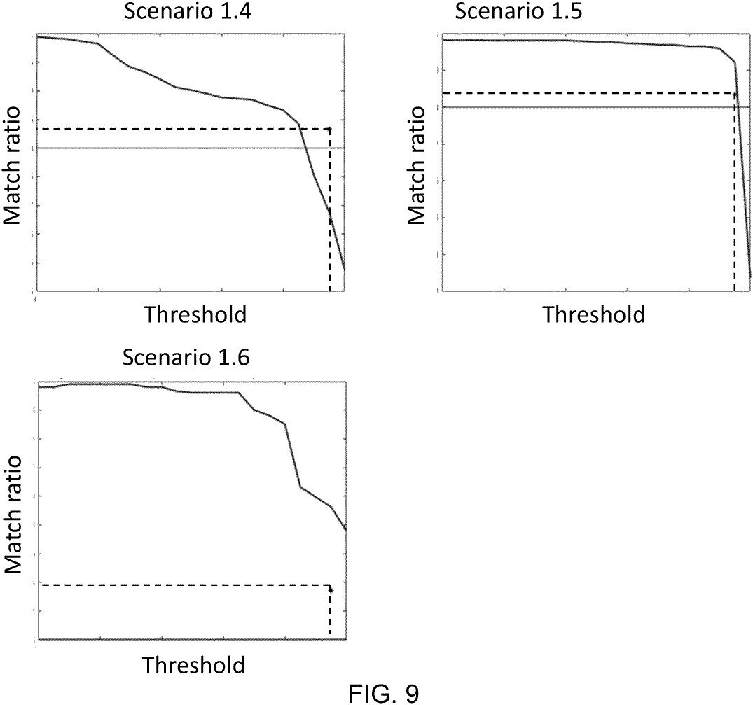

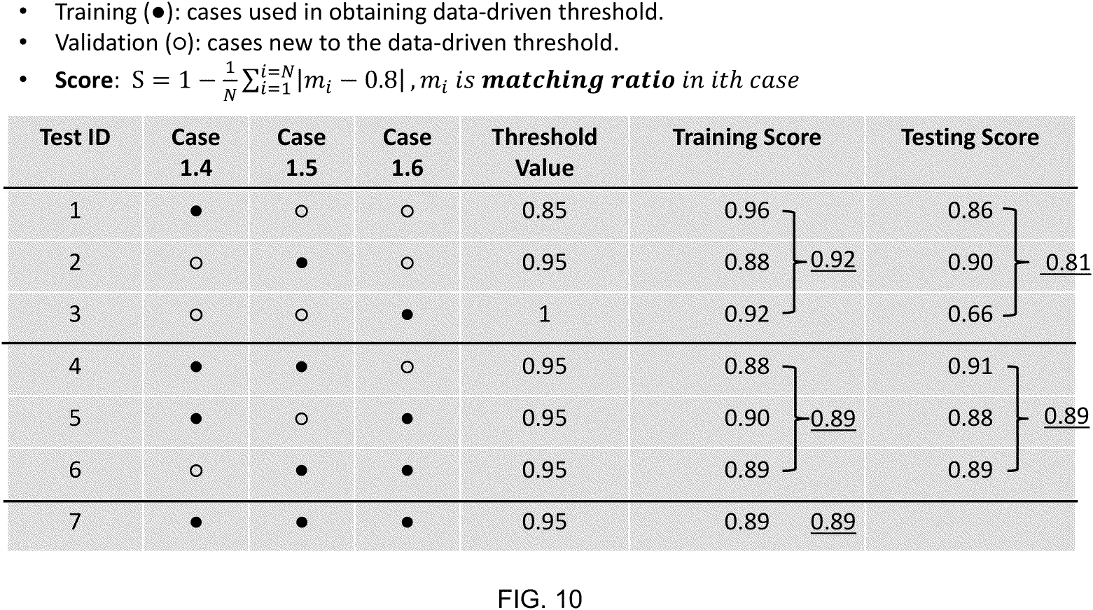

The method uses a selection criterion to differentiate good trial model from less-good trial models to generate the refined models. The selection criterion may be a data fit tolerance that is user input as shown in box 24. In an embodiment, the selection criterion may be a threshold value that is below the 3D-data fit of the reference (input) model. This is demonstrated in FIG. 5. In another embodiment, the selection criterion may be data-driven. The data-driven threshold may be determined by using mis-tie information to derive an optimal threshold such that the estimated depth uncertainty range statistically matches the mis-tie data. This may be done, by way of example but limitation, by forming a soft thresholding which assigns probability based on data fit, such as from averages semblance, as shown in FIG. 6. This can be further improved by bootstrap sampling and optimizing the threshold to allow the depth uncertainty estimates to statistically match any available mis-tie data. By way of example and not limitation, the threshold level may be set such that the mis-tie will be within the P10-P90 range 80% of the time, as shown in FIG. 7. FIG. 8 and FIG. 9 further illustrate this. In an embodiment, the threshold may be validated using a V-fold cross validation to evaluate its performance, as shown in FIG. 10.

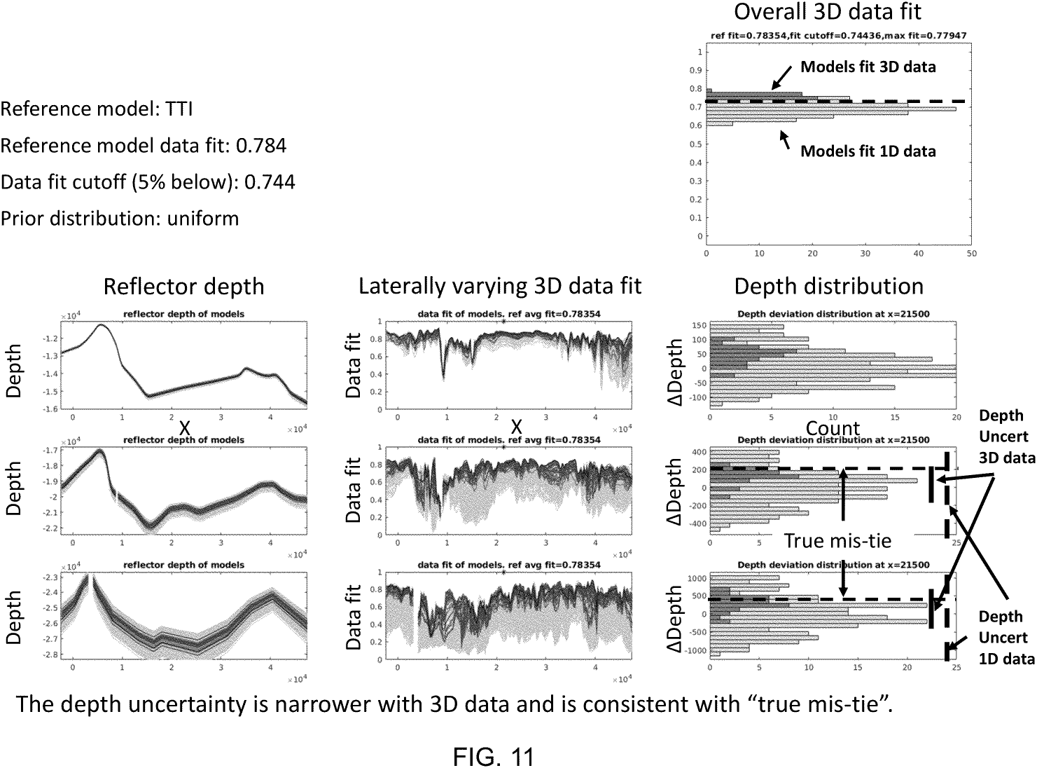

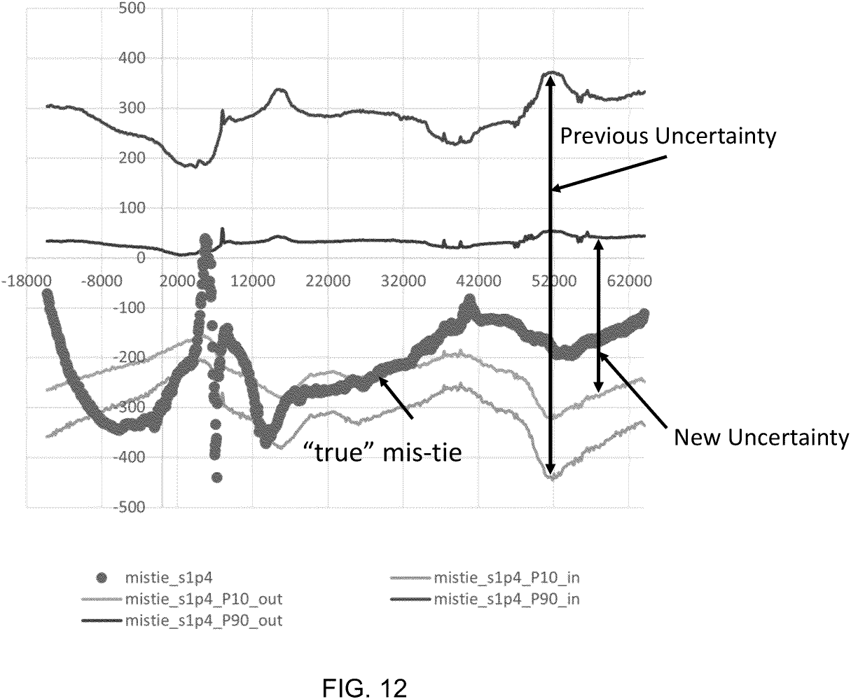

The refined models that pass the selection criterion are used to calculate the depth uncertainty in box 26. The method determines depth uncertainty statistics based on models that satisfy the selection criterion for a user-defined area of interest (AOI). In an embodiment, the depth computation may be vertical integration of seismic velocity through all the selected models. FIGS. 11 and 12 show examples of results of the method. FIG. 11 shows the 3D-data fit for all trial models and refined models, respectively. It also shows the corresponding depth uncertainty associated with all trial models and refined models, respectively. After model refinement, the depth uncertainty could be less than that of models before refinement. FIG. 12 shows the difference between depth uncertainty in terms of P10-P90 range from all trial models and refined models, comparing with mis-tie data in one case. The method may also produce refined model realizations that can be used to estimate other types of uncertainties such as volume uncertainty.

Method 200 improves the depth uncertainty estimation as compared to conventional methods of depth uncertainty estimation (i.e., it provides a narrower uncertainty range that is reliable). The key differentiators of the new approach are more physically accurate depth uncertainty estimation, an efficient implementation that is feasible for field data application, and more reliable depth uncertainty estimates.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of estimating depth uncertainty, comprising:
a. receiving seismic data, a reference model, and trial model realizations;
b. generating realization gathers from the trial model realizations;
c. generating reference gathers from the reference model;
d. determining a reference data fit based on the reference gathers and data fits for trial models based on the realization gathers;
e. selecting refined models from the trial model realizations based on the reference data fit, the data fits for trial models, and a data fit tolerance criterion; and
f. calculating depth uncertainty based on statistics of the refined models.

2. The method of claim 1 wherein the trial model realizations are generated using stochastic modeling of velocity V and anisotropic parameters η and δ.

3. The method of claim 1 wherein the realization gathers are generated using gaussian-beams with 3D physics.

4. The method of claim 1 wherein the data fit criterion is a user-defined threshold or a data-based threshold.

5. The method of claim 4 wherein the data-based threshold is derived from mis-tie data from well logs and the seismic data.

6. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive seismic data, a reference model, and trial model realizations;
b. generate realization gathers from the trial model realizations;
c. generate reference gathers from the reference model;
d. determine a reference data fit based on the reference gathers and a data fit for trial models based on the realization gathers;
e. select refined models from the trial model realizations based on the reference data fit, the data fit for trial models, and a data fit tolerance criterion; and
f. calculate depth uncertainty based on statistics of the refined models.

7. The system of claim 6 wherein the trial model realizations are generated using stochastic modeling of velocity V and anisotropic parameters η and δ.

8. The system of claim 6 wherein the realization gathers are generated using gaussian-beams with 3D physics.

9. The system of claim 6 wherein the data fit criterion is a user-defined threshold or a data-based threshold.

10. The system of claim 9 wherein the data-based threshold is derived from mis-tie data from well logs and the seismic data.

11. A non-transitory computer readable storage medium storing one or more programs, the one or more programs comprising instructions, which when executed by an electronic device with one or more processors and memory, cause the device to:
a. receive seismic data, a reference model, and trial model realizations;
b. generate realization gathers from the trial model realizations;
c. generate reference gathers from the reference model;
d. determine a reference data fit based on the reference gathers and data fits for trial models based on the realization gathers;
e. select refined models from the trial model realizations based on the reference data fit, the data fits for trial models, and a data fit tolerance criterion; and
f. calculate depth uncertainty based on statistics of the refined models.

12. The device of claim 11 wherein the trial model realizations are generated using stochastic modeling of velocity V and anisotropic parameters η and δ.

13. The device of claim 11 wherein the realization gathers are generated using gaussian-beams with 3D physics.

14. The device of claim 11 wherein the data fit criterion is a user-defined threshold or a data-based threshold.

15. The device of claim 14 wherein the data-based threshold is derived from mis-tie data from well logs and the seismic data.
